(19) United States
(12) Patent Application Publication
(10) Pub. No.: US 2003/0155679 A1
(43) Pub. Date: Aug. 21, 2003

(54) Method of making regenerated carbohydrate foam compositions

(76) Inventors: William G. Reeves, Appleton, WI (US); Li-fu Chen, West Lafayette, IN (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/038,761

(22) Filed: Dec. 31, 2001

(51) Int. Cl. B29C 44/00

(52) U.S. Cl. 264/50; 264/51; 264/175

(57) ABSTRACT

The present invention provides a method of making a carbohydrate foam composition. The method produces a foam composition is highly wettable, resilient and has a uniform pore structure suitable for use in products such as absorbent personal products, health care products, and products suitable for fluid distribution and transfer. The foam of the present invention may also be made into sheets suitable for products such as tissue and paper towels. In one embodiment the foam is made from a carbohydrate and zinc chloride. In a further embodiment the carbohydrate is cellulose, and in a further embodiment the carbohydrate is chitin. The method of the present invention allows control over various properties of the foam carbohydrate composition.

### BACKGROUND OF THE INVENTION

1. Field of the Invention

This invention relates to novel methods of making and using absorbent foam compositions. Specifically, the invention relates to methods of making foam compositions useful for fluid absorption and transport and suitable for use in a variety of personal care products such as facial tissue, paper towels, bandages, feminine care products, and diapers.

2. Description of the Related Art

Many foam products exist today, and different processes are used to create an assortment of foam materials. Various foam compositions comprise a range of products such as sponges, insulation, packing materials, and personal care and medical products. Highly absorbent foams are needed for use in cleaning, personal care, and health care products. It is known in the art to use carbohydrates, such as cellulose and chitin, to make absorbent foams.

Cellulose, the most abundant polymer on earth, is a straight-chain polymer of anhydroglucose with beta 1-4 linkages. It is the structural polymer for all plant life. Cellulose fiber in its natural form comprises such materials as cotton, wood and hemp, while processed cellulose fibers make up products such as paper, paper-products, and textiles. Cellulose has also been chemically processed to form materials such as rayon and cellulose acetate. Cellulose can also be used to manufacture foam products. Applications of porous cellulose include cellulose sponges, foam cellulose sheets and other foam materials.

Chitin, the second most abundant polymer on earth, is a polysaccharide that forms part of the hard outer integument of insects, arachnids, and crustaceans as well as being the structural polymer for fungi. Chitin is commonly used as a flocculating agent for wastewater, a wound healing agent, a thickener and stabilizer for foods and pharmaceuticals, an ion-exchange resin, a membrane for chromatography and electro dialysis, a binder for dyes, fabrics, and adhesives, and a sizing and strengthening agent for papers. Due to chitin's anti-microbial activity and wound healing properties, it would be desirable to utilize chitin when making foams for use in various foam products, particularly health care and personal care foam products.

An advantage to creating foam products from cellulose is that cellulose is an abundant and recyclable material. However, difficulties are encountered in attempting to recycle used cellulose products available in large quantities, such as used paper and wood pulp, into a high-quality end use product. Typically, a recyclable starting product, such as mixed office waste, will, when recycled, become a lower value material. This occurs in part because of the contaminants introduced during the initial use that must be removed before successful reprocessing can occur. For papermaking processes, an additional factor is that when used paper is re-pulped the cellulose fibers become damaged and the resulting pulp, when re-used, will not form as high quality a product as an un-damaged or virgin pulp. It would therefore be advantageous to find a process for converting used paper, such as mixed office waste, into a product of equivalent or higher value.

Prior art methods of producing porous cellulose materials teach the use of porogens, insoluble particles added to the cellulose solution and later leached out to produce pores in the cellulose product. These prior art cellulose sponges are generally manufactured by first making a viscose solution to which the porogens are added to form a paste. The paste is then molded and regenerated. After regeneration is complete, the porogens are dissolved to leave pores in the cellulose product. U.S. Pat. No. 3,261,704 describes this basic process.

Typical porogens used in manufacturing cellulose sponges include trisodium phosphate crystals (U.S. Pat. No. 3,261,704), sodium sulfate crystals (U.S. Pat. No. 3,554,840), mirabilite (J0309067-A), and polyethylene glycol (GB2,086,798). Sodium sulfate crystals generally produce a product with larger pores, suitable for sponges (J0251422-A), whereas polyethylene glycol can be used to produce small pores, creating a product suitable for ultrafiltration or blood dialysis (GB 2,086,798 and U.S. Pat. No. 4,824,569, respectively).

The use of porogens to create pores in the cellulose is undesirable for several reasons. The removal of the porogens adds a processing step, with its attendant costs and difficulties. It is normally necessary to recycle the porogens after removal, adding still more cost and further opportunities for process problems. Additionally, porogens create difficulty in controlling the pore size and the density of the resulting product.

In other prior art methods, blowing agents are used to produce pores. U.S. Pat. No. 4,172,735 describes a cellulose foam produced by the use of blowing agents and a surfactant rather than porogens; however, the foam produced has closed cells and is not absorbent. A Japanese patent, JP06065412-A, also teaches the use of a blowing agent to form a foamed material, but this material also lacks absorbent properties and open cells.

Additionally, many prior art cellulose foams are made from a viscose starting material. Disadvantages to using viscose include the lengthy processing and aging steps required to form a viscose solution, the environmental discharges produced by the process, and the need for a starting material of very high purity. A method of making cellulose foams out of easily attainable starting materials with little to no required aging time would be advantageous for various reasons. This eliminates time consuming processing and aging steps. A method in which the purity of the starting material is not a rigid requirement allows for almost immediate recycling of abundant cellulose waste materials such as mixed office waste. Foams made according to the viscose process also undergo considerable shrinkage and may become unevenly deformed and compacted during drying, making it difficult to obtain a low density foam with a uniform pore structure on a continuous basis. Attempting to form viscose sponges without porogens by using blowing agents or whipping yields sponges with uneven pore structure that lack the resilience found in standard cellulose sponges, such as Ocello® sponges, made from viscose cellulose with porogens.

Prior art foamed chitin compositions are also prepared according to the viscose process. For example, U.S. Pat. No. 5,756,111 describes a viscose containing a combination of chitin-chitosan and cellulose in which a foaming agent is added to produce foam materials. However, the disadvantages to the viscose process are discussed above, and the use of foaming agents is more expensive than air foaming. Furthermore, according to prior art processes for producing chitin containing foams, it is impossible to foam pure chitin. Instead, chitin must be added to a viscose solution or otherwise combined with a solution of a different carbohydrate to be processed. Thus, it would be advantageous to find a method for producing a pure chitin foam and thereby avoid the costly viscose process.

The high capital costs and environmental concerns associated with the viscose process has led to a search for modified or alternate methods for solubilizing cellulose and chitin for making regenerated cellulose and chitin fibers and foams. Solvents comprising solutions of SO₂/NH₃ and SO₂/(CH₃)₂HN have been tested and found to form good cellulose solutions in terms of reasonable viscosities and practical degrees of polymerization, but proved impractical for regenerating cellulose fibers and recovering the solvent from the coagulation medium.

The oldest US patent for cellulose fibers describes cellulose dissolved in zinc chloride and spun, but this process was later abandoned in favor of the viscose process. The advantage of the viscose process over the prior process was that the zinc chloride was difficult to remove from the relatively coarse fibers that were the limit of the art at that time (1890s). Later attempts at using zinc chloride as a cellulose solvent were not promising; D. M McDonald reported that a 64% ZnCl₂ solution was tested as a possible cellulose solvent and proved unworkable because the solubilized cellulose could not be spun and the coagulated fibers were non-cohesive. See D. M. McDonald's The Spinning of unconventional Cellulose Solutions in Turbak et. al, “Cellulose Solvent Systems” ACS Symp. Seri. 58 (1977). Although zinc chloride has more recently been successfully employed as a cellulose solvent in the production of high tensile strength, solvent-spun cellulose fiber (U.S. Pat. Nos. 5,290,349 and 4,999,149 to Chen), there is no suggestion that such solvents would be appropriate for creating foamed cellulose materials. Moreover, there is still disagreement in the art regarding the effectiveness of zinc chloride as a cellulose solvent for various applications, particularly foaming applications since concentrated salt solutions are conventionally used to destroy foams. Thus, the viscose process remains the primary method employed for processing cellulose and chitin in production of various carbohydrate based materials, including foamed carbohydrate materials.

Accordingly, what is needed in the art is a porous carbohydrate material with controllable cell size, formed without the use of porogens or the viscose process. Also needed in the art is a method of making an absorbent carbohydrate foam with controllable cell size and density, without the use of porogens or the viscose process. A method is also needed which allows formation of a high-quality end use cellulose product from recycled secondary quality cellulose waste products, such as mixed office waste. Also needed are various cellulose foam products and foam sheets with large pores which are suitable for fluid pickup and distribution, such as absorbent products, including but not limited to, paper towels, facial tissue, sanitary napkins, diapers, and bandages. Another need in the art is for a porous cellulose product with a small pore size useful for separations.

There is also a need in the art for a chitin foam material suitable for use in personal care and health care products, which will benefit from the skin healing properties of chitin. A method is needed which allows formation of a chitin foam material without the use of the viscose process. A need also exists for a resilient cellulose or chitin foam material with controllable and uniform pore size produced by air foaming. Thus, what is needed in the art is a method of solubilizing cellulose and/or chitin wherein the cellulose/chitin may be successfully foamed and regenerated into a high quality product and wherein the solvent may be easily recovered.

### SUMMARY OF THE INVENTION

In accordance with the present invention, a foamed composition may be produced from a carbohydrate source without the use of porogens.

In accordance with the present invention, a method of producing a foamed composition from a carbohydrate by air foaming is taught.

In accordance with the present invention, a foam composition is produced from an air foamed mixture of cellulose and an aqueous salt solution.

In accordance with the present invention, a foam composition is produced from an air foamed mixture of chitin and an aqueous salt solution.

In accordance with the present invention, a foam composition is produced from an air foamed mixture of cellulose and zinc chloride solution.

In accordance with the present invention, a foam composition is produced from an air foamed mixture of chitin and zinc chloride solution.

In accordance with the present invention, a method of making a foam with controllable pore size suitable for various applications is taught.

In accordance with the present invention, a foamed cellulose sheet and method of making such foamed sheet is disclosed.

In accordance with the present invention, a foamed cellulose sheet and method of making such a foamed sheet on a supporting substrate is disclosed.

In accordance with the present invention, a highly wettable, resilient foam appropriate for use in absorbent personal care products is disclosed.

The present invention generally provides foamed compositions and products comprising the foamed compositions and methods of making the foamed compositions. The foam of the present invention has characteristics suitable for use in various absorbent articles, including personal care and health products, such as bandages, diapers, and feminine care articles. The foam of the present invention is formed from a carbohydrate composition, more particularly from a cellulose or chitin composition. The foam may be in the form of a sheet appropriate for products such as tissue and paper towels. The invention also provides a foam with small pore size suitable for separations, such as desalination of a protein solution.

The present invention also provides foamed cellulose compositions formed from recycled cellulose materials. This invention contributes to the environment by converting secondary cellulose materials into useful, high-quality regenerated cellulose foam, and products containing the foam.

The invention also provides a process for forming a wettable, resilient, open-celled foam, useful for absorbing and/or transporting fluids. The process of the invention eliminates porogens by using air to form a foam. The use of air foaming allows greater control over pore size and connectedness. Mechanically beating air into the cellulose material allows creation of a foam with greatly reduced processing costs and eliminates costs and recycling problems associated with porogens. This process also allows production of the foam directly from the cellulose or chitin source without having to first create a chemical derivative, as required by the viscose process, thereby eliminating time, costs, and environmental problems associated with such processes.

The invention additionally provides a method for making a regenerated cellulose or chitin foam that allows control over pore size, foam structure, and other properties of the foam, such as absorbance and wet/dry strength, by changing compositional or processing variables. This process allows generation of a foam that is highly wettable and resilient. A foam of the present invention has a multitude of pores, resulting in a total surface area ranging from 0.9 m²/g to 3.2 m²/g, as compared to the average surface area of standard polyurethane foams and kitchen sponges, which have an average surface area of much less than 1 m²/g. A foam of the present invention may also be formed on a support structure for increased strength and durability.

The present invention generally comprises a process in which a pre-wetted carbohydrate is mixed with an aqueous salt solution of sufficient concentration to at least partially dissolve the carbohydrate to form a carbohydrate salt complex. Desirably, the carbohydrate is a water insoluble carbohydrate. More particularly, the aqueous salt solution contains a salt having a Hammett acidity between approximately +2 and −3, such as zinc chloride. The carbohydrate is desirably cellulose, starch, pectin, alginic acid, chitin or chemical derivatives thereof.

This carbohydrate-salt mixture is then optionally combined with a surfactant and any other additives, such as a crosslinking agent, and air foamed. Once foamed, the carbohydrate may be regenerated by either washing with water, or by first removing the excess salt with an organic solvent, such as ethyl alcohol, and then washing with water. After regeneration and washing, the foam is dried.

The present invention is advantageous, therefore, for it teaches the creation of a foamed carbohydrate composition without using the viscose process and without the use of porogens and teaches the unexpected use of an aqueous salt solution as a carbohydrate solvent in a foaming process, unexpected because concentrated salt solutions are commonly used in the art to destroy foams.

Desirably the salt is ZnCl₂, which is a beneficial solvent because ZnCl₂ has a low toxicity, is less corrosive than previously employed solvents, and is easily recoverable for reuse. The recovery and re-use of the zinc chloride also provides economic advantages. The methods of recovery and recycling of zinc chloride solution are known to those of skill in the art. Some of the principle methods of recovery include evaporating diluted solutions of aqueous zinc chloride, such as that recovered from washing, and precipitating the zinc as the carbonate by the addition of a solution such as sodium carbonate to dilute aqueous solutions of zinc chloride.

Another benefit of the present invention is that any water-insoluble carbohydrate, including but not limited to cellulose, chitin, starch, pectin, or alginic acid, can be used in the present invention due to the disruption of the internal hydrogen bonds of such carbohydrates through complexation by the aqueous salt solution. Because the dissolution process is general to the family of carbohydrates, it is possible to mix multiple carbohydrates together in one structure, thus obtaining unusual and valuable properties. In addition, this process allows the formation of high quality foam products from abundant and inexpensive cellulose sources, including mixed office waste, which has the added advantage of benefiting the environment. This process also provides foam products with the skin healing properties of chitin for use in personal care and health care products.

These and further advantages of the present invention will become apparent after a review of the following detailed description of the disclosed embodiments.

### DETAILED DESCRIPTION OF SPECIFIC EMBODIMENTS

The present invention can be more clearly understood by referring to the following detailed description and specific examples. Although various changes and modifications within the spirit and scope of the invention will become apparent to those skilled in the art from reading this description, the description and examples are presented as illustrations and not intended to limit the scope of the invention in any way.

The present invention is directed to a foamed carbohydrate composition and a method of making a foamed carbohydrate composition. The invention achieves the above-mentioned advantages through a novel combination of materials and processing.

The process generally involves at least partially dissolving a pre-wetted water insoluble carbohydrate material in an aqueous solution of low Hammett acidity to form a carbohydrate-salt complex, optionally adding a surfactant, mechanically beating air into the solution to form a foam, and optionally regenerating the cellulose.

Carbohydrates, as defined in this invention, are polymers containing linked sugars. Despite being composed of sugars, which are water-soluble as individual molecules, the larger carbohydrates are water insoluble due to extensive internal hydrogen bonding between the alcohol substituents of the sugar monomers. These molecules have hydrophilic and hydrophobic regions, usually based on the degree of sidedness for the hydroxyl substituents of the sugar ring. Any carbohydrate that is water insoluble due to internal hydrogen bonding may be used in the method of the present invention. Carbohydrates suitable for use in the present invention include, but are not limited to cellulose, starch, pectin, alginic acid, chitin or chemical derivatives thereof. Desirably, the carbohydrate is cellulose or chitin.

In the present invention, metallic salts of sufficiently low Hammett acidity, such as zinc and calcium ions, are used to disrupt the internal hydrogen bonding of the carbohydrates. The metallic salts form water soluble metal complexes with the water insoluble carbohydrates and alter the arrangement of the hydrophobic and hydrophilic regions of these carbohydrates once in solution. Examples of salts useful in the present invention include, but are not limited to, zinc thiocyanate, zinc halides such as zinc chloride, zinc bromide and zinc iodide, cadmium thiocyanate, cadmium halides such as cadmium chloride, cadmium bromide and cadmium iodide, titanium thiocyanate, titanium halides such as titanium chloride, titanium bromide and titanium iodide, zirconium thiocyanate, zirconium halides such as zirconium chloride, zirconium bromide and zirconium iodide, lithium thiocyanate, and lithium halides, such as lithium chloride, lithium bromide and lithium iodide, calcium thiocyanate, calcium halides, including calcium chloride, calcium bromide, and calcium iodide, magnesium thiocyanate, magnesium halides, including magnesium chloride, magnesium bromide, and magnesium iodide, strontium thiocyanate, strontium halides, including strontium chloride, strontium bromide, and strontium iodide, potassium thiocyanate, potassium halides such as potassium chloride, potassium bromide and potassium iodide, guanidinium thiocyanate, N-methyl morpholine oxide, or mixtures thereof. Desirably, the salt is zinc chloride because of its low cost and safety for human contact.

Hammett acidity is a measurement which is used for acidic solvents of high dielectric constant. The dielectric constant is a measure of the ion-solvating ability of the solvent. The Hammett acidity, H₀ is defined as:

$${H}_{0} = {pK}_{{AH}_{W}^{+}} + log \frac{[ A ]}{[ {AH}^{+} ]}$$

Where [A] is the concentration of the conjugate base of the solvent acid-base pair and [AH⁺] is the concentration of the corresponding conjugate acid. In the method of the present invention, it is desirable for the salt to have a Hammett acidity from approximately +2 to approximately −3. More desirably, the salt has a Hammett acidity from approximately 0 to approximately −2. More specifically, when dissolving cellulose from wood pulp, the Hammett acidity is desirably from about −1 to about −3. For more easily dissolved carbohydrates such as starch or very low molecular weight cellulose, the Hammett acidity is desirably from about +1 to about 0.

Examples of salts that have sufficiently low Hammett acidity to at least partially dissolve carbohydrates as insoluble as cellulose include, but are not limited to, zinc thiocyanate, zinc halides such as zinc chloride, zinc bromide and zinc iodide, cadmium thiocyanate, cadmium halides such as cadmium chloride, cadmium bromide and cadmium iodide, titanium thiocyanate, titanium halides such as titanium chloride, titanium bromide and titanium iodide, zirconium thiocyanate, zirconium halides such as zirconium chloride, zirconium bromide and zirconium iodide, lithium thiocyanate, and lithium halides, such as lithium chloride, lithium bromide and lithium iodide, or mixtures thereof. Examples of salts that have a sufficiently low Hammett acidity to dissolve relatively less insoluble carbohydrates, such as starch, include but are not limited to, calcium thiocyanate, calcium halides, including calcium chloride, calcium bromide, and calcium iodide, magnesium thiocyanate, magnesium halides, including magnesium chloride, magnesium bromide, and magnesium iodide, strontium thiocyanate, strontium halides, including strontium chloride, strontium bromide, and strontium iodide, potassium thiocyanate, potassium halides such as potassium chloride, potassium bromide and potassium iodide, guanidinium thiocyanate, N-methyl morpholine oxide, or mixtures thereof. Desirably, the salt is zinc chloride and the aqueous salt solution contains from approximately 60% to approximately 75% zinc chloride.

When mixed with an aqueous solution of one of the above salts, at least partial dissolution of the water insoluble carbohydrate will occur due to the disruption of the internal hydrogen bonds of the carbohydrate. This disruption of the internal hydrogen bonds allows formation of a carbohydrate salt complex, but some physical entanglement of the carbohydrate remains intact. Additional stirring of the mixture will break these entanglements and will lower the viscosity of the mixture. As used herein, “at least partial dissolution” means that between approximately 30% and approximately 100% of the carbohydrate dissolves in the aqueous salt solution, however the degree of dissolution depends on many factors, including the extent of physical stirring of the mixture, the temperature of the mixture, the type of salt used, the concentration of the aqueous salt solution, the type and amount of water insoluble carbohydrate used. Thus, it will be understood by those of skill in the art that variations in the above percentages of dissolution due to the above factors are within the scope of the invention. Additionally, it will be understood by those of skill in the art that degree of dissolution of the carbohydrate does not include the presence of insoluble impurities in the carbohydrate, such as lignin in the case of cellulose.

The regeneration may occur by washing with water, or by first removing excess salt with any organic solvent which dissolves the salt, including, but not limited to alcohols such as methanol, ethanol, and iso-propanol; ketones such as acetone and methyl ethyl ketone; esters such as ethyl acetate; and nitrites such as acetonitrile, and subsequently washing with water. The regenerated foam is then dried. Methods of drying include, but are not limited to, heat drying, freeze-drying, or dewatering with absorbent materials. The properties of the foam, such as pore size and structure, can be controlled by changing compositional variables, such as percentages of carbohydrate or surfactant, or processing variables, such as beating method, temperature, blow ratio, or drying method. As used herein, “blow ratio” is the volume of foam divided by the volume of liquid used to prepare the foam.

According to the method of the present invention the carbohydrate source is pre-wetted with a wetting agent. This pre-wetting step enhances the penetration of the salts solution into the solid carbohydrate particles. Desirably the wetting agent is water or a salt solution, such as a zinc chloride solution of less than about 30% concentration of zinc chloride. Desirably, the carbohydrate is pre-wetted with at least 1:3, more desirably 1:2, and most desirably a 1:1 or higher ratio of wetting agent to carbohydrate.

Any water insoluble carbohydrate may be used in the invention. Desirably, the carbohydrate source is cellulose or chitin. Various cellulose sources may be used according to this process. Possible sources include Avicel®, a high quality food grade additive; Chitopure® (Biopolymer Engineering, St. Paul, Minn.), wood pulps, such as CR54 (Coosa River) Bleached Southern Softwood Pulp; and recyclable waste paper, such as mixed office waste. However, other carbohydrates may be used including, but not limited to, pectin, alginic acid, starch, and chemical derivatives of these materials.

The pre-wetted carbohydrate source is then heated in an aqueous solution to aid dissolution. Desirably, the aqueous solution is zinc chloride, more desirably a zinc chloride solution with a concentration of approximately 60% to a saturated solution of zinc chloride in water (typically, a saturated solution at room temperature contains about 74% zinc chloride in water, but may be slightly higher at higher temperatures), more desirably approximately 65% to approximately 70% zinc chloride in water, most desirably approximately 67% zinc chloride in water. Other salt additives, such as calcium salts, particularly calcium chloride, can be added at this stage as well; such salts have been found to increase the strength of the foamed sheet. The carbohydrate and aqueous solution is desirably mixed to dissolve the carbohydrate.

During the dissolution step the temperature is desirably maintained at a temperature from about room temperature (generally about 20° C.) to about 95° C., more desirably, from about 35° to about 85° C., and most desirably, from about 60° to about 80° C., to ensure optimal dissolution of the carbohydrate.

After dissolution a surfactant may be added to the dissolved cellulose to aid in foaming. Appropriate surfactants include, but are not limited to, the following compounds: Sole-Terge™ 8 (Calgene Corp); Synthrapol™ KB (ICI America); Glucopon™ 625 (Henkel); PLURONIC™ 92, L81, L101, F108, and F168 (BASF); Varisoft™ 442-100P (Witco); IGEPAL™ CA-630 (Rhone-Poulenc); BRIJ™ 35 and 52 (ICI America); Standapol™ ES-3 (Henkel); FC 135, 170C, and 171 (3M); Phospholipid PTC (Mona Industries); Dabco™ CD5604 (Air Products); and Hexadecyltrimethylammonium bromide (HTAB) (Aldrich Chemical Co.). At this point crosslinking agents, such as Kymene™ 557LX (Hercules, Inc.) and Parez™ 631-NC (Cytec Industries), may also be added, if desired, to increase the strength of foam sheets for applications such as tissue.

The cellulose composition is then desirably mixed with a gas to create a foam. Desirably the gas is air, though other non-reactive gases may be used including, but not limited to, carbon dioxide gas, nitrogen gas, helium and argon. Mixture with air can be accomplished by mechanical frothing, such as beating the composition into a foam with a hand mixer or by means of an industrial scale mixer (for foaming higher viscosity compositions) where air is injected into the mixer at a constant rate. The source of the gas can also be a chemical added to the carbohydrate solution that decomposes, typically with heat though other activating agents are known in the art, to produce a gas. These materials are known as blowing agents and are the material of choice for higher viscosity solutions. Examples of blowing agents would include ammonium chloride, which decomposes on gentle heating to form two moles of gases, and ammonium carbonate, which decomposes with slightly greater heating to form three moles of gas.

The choice of equipment for preparing a cellulose foam depends, to some extent, on the viscosity of the cellulose mixture to be foamed. Low viscosity mixtures, for example 1% Avicel in 67% zinc chloride, may be foamed with a hand mixer and air. Both low and medium viscosity mixtures may be foamed in a mechanical foamer, which has the additional advantage of continuous output. An example of a medium viscosity material may have a composition of 5% Avicel in 67% zinc chloride, or 1% mixed office waste (MOW) in 67% zinc chloride.

Once foaming is complete, the foam may then be regenerated by washing with water. Alternatively, the regeneration may be accomplished in a two-step process by first removing the excess ZnCl₂ with an organic solvent, such as ethyl alcohol, and subsequently washing the foam with water to regenerate the cellulose from the cellulose zincate.

In another embodiment, the foams may additionally be placed in an aqueous bath of about 1% to about 20% glycerol to prevent the foam from becoming too hydrophobic over time. The glycerol bath also improves the hand feel of the foam which is advantageous in applications such as facial tissue and other personal care products.

After regeneration, the foam is dried, which converts the product to its final form. Drying may be accomplished by any number of methods, which include, but are not limited to, freeze drying, use of a desiccant, air drying, and oven drying. The method of drying at least in part determines the pore structure of the resulting product. Freeze-dried foams tend to have a uniform distribution of fine pores and have excellent wicking characteristics, while oven dried foams have a uniform distribution of large pores and intake fluid rapidly. Chemical drying gives a mixture of large and fine pores. The difference is believed to be due to the stiffness of the pore walls when the water is removed. Capillary pressure from increasingly small amounts of water will draw together walls if they are able to move. Freeze drying prevents wall movement and keeps the original structure. Oven drying sacrifices the smallest pores and, consequently, allows the remaining pores to expand.

If foamed sheets are desired, the foam may be spread over a forming surface, such as a Mylar®, sheet or a Teflon® coated glass plate, for example, with a spreader having a fixed gap. After regeneration and drying, the foam sheet may be pressed, such as with a roller to reduce the stiffness of the sheet and open the cells of the cellulose foam. In other cases, the “windows” of the foam are sufficiently thin that they open spontaneously during regeneration. The foam can also be spread on a support sheet, such as a spunbonded or meltblown web or an apertured extruded sheet. When polyolefin supports, such as spunbonded or melblown polypropylene, are used, the cellulose foam unexpectedly adheres strongly to these hydrophobic webs without the need for any additional bonding agents.

By varying the components or processing steps, different types of foams can be created in accordance with the present invention. This invention allows control over the properties of the foam, such as pore size, structure, absorbency, wet/dry strength, and surface area, by changing compositional variables, such as percentages or type of carbohydrate, surfactant or crosslinking agent, or processing variables, such as beating method, temperature, blow ratio, regeneration steps, or drying method.

A foam according to the present invention can also be formed from a mixture that contains both cellulose in solution and incompletely dissolved cellulose fibers. The final foam can be reinforced through the use of partially dissolved fibers, greatly increasing the strength and tenacity of the foam product. Also, such partially dissolved fibers act to break the “windows” of the foam cells, producing a desirable open-celled foam without the need for a rolling step, as described above.

The present invention is further illustrated by the following examples, which are not to be construed in any way as imposing limitations upon the scope thereof. It will be clear to one of skill in the art that various other modifications, embodiments, and equivalents thereof exist which do not depart from the spirit of the present invention and/or the scope of the appended claims.

### EXAMPLE 1

Regenerated cellulose foam sheets were prepared according to the following process. 16.2 g of reagent grade zinc chloride was dissolved into 6.0 g of distilled water to form a 73% (w/w) zinc chloride solution. An appropriate weight (see table below) of cellulose in the form of Avicel® microcrystalline cellulose powder available from FMC Corporation, Philadelphia, Pa. was pre-wet with 2.0 g of distilled water and added, with stirring, to the previously prepared 73% zinc chloride solution, which had been heated to 65° C. An appropriate amount (see table below) of surfactant, either Sole Terge™ 8 or Synthrapol™ KB, was added, and the cellulose-surfactant-zinc chloride mixture was beaten with a hand mixer for 10 minutes to create a foam. The foam was then spread on a Teflon-covered glass sheet with a thin layer chromatography spreader set for a ⅛″ slice.

The foam was then regenerated by a two step process. First the foam was dipped into a pan partially filled with ethyl alcohol for approximately 10 minutes to allow the excess zinc chloride to leach out. Then the foam was placed in a container of water for approximately 10 minutes to regenerate the cellulose from the cellulose zincate complex. After regeneration, the foam was washed with a 1% glycerine/water solution, which acts as a plasticizer for the cellulose. The foam was then dried in a freeze drying apparatus and the foams were analyzed for various properties. The foams were imaged in both top and cross-section using SEM and the images analyzed using the Quantimet Image Analysis System. The results show the foams are open celled; percent open area and wall thickness for the foams are presented in the table below. The foams were also tested for total surface area by BET analysis, which was conducted by Micromeritics, Norcross, GA using their standard methodology for BET determination. The results are provided in Table 1, below.

TABLE 1

| Experiment | % cellulose | surfactant | % surfactant | open area | wall thickness | BET surface a |
|---|---|---|---|---|---|---|
| 1 | 2 | Sole terge 8 | 0.25 | 46% | 18u | — |
| 2 | 2 | Sole terge 8 | 1.0 | 55% | 22u | 3.20 |
| 3 | 3 | Sole terge 8 | 0.75 | 40% | 26u | 2.84 |
| 4 | 4 | Sole terge 8 | 0.5 | 10% | 131u | — |
| 5 | 4 | Sole terge 8 | 2.0 | 19% | 64u | 2.89 |
| 6 | 4 | Synthrapol KE | 2.0 | 59%u | 188 | .88 |
| 7 | 4 | Synthrapol KE | 4.0 | 37% | 52u | .89 |

### EXAMPLE 2

Foam sheets were prepared according to the process of Example 1 using 3% Avicel® as the cellulose source. Various surfactants were tested (see table below) and cross-linking agents were added prior to foaming to increase the strength of the foam sheets. The table below lists the type and percentage of cross-linking agent used. In these experiments, the foam sheets were dried in a 70° C. oven for half an hour.

Additional properties of the foam sheets were analyzed, including wet strength, breaking force, sheet thickness, and cross-sectional area. Dry and wet strength measurements, well as breaking force, were obtained through an Instron™ test. The method was to place an 0.5″ wide sample with a length greater than 1.5″ into 1″ jaws on an Instron machine, model 1132. The jaws were spaced 1″ apart, so the size of the sample being tested was 0.5″ by 1″. The jaws were separated at a rate of 5 cm/minute until the sample broke. The force being exerted was recorded with a mechanical strip chart recorder. The Instron was equipped with a Tensile Load Cell A, model D30 36. Breaking force represents the maximum value shown on the chart, while strength is the area under the curve during the entire test. When wet strength is indicated, the samples had been saturated with water; when dry strength is indicated, the samples were tested following the drying technique described. Thickness was measured with a micrometer and cross area is the thickness multiplied by the length held by the jaws. The results are presented in the table below.

TABLE 2

| Wet strength | Breaking | | Cross Area | | Cross-linking |
|---|---|---|---|---|---|
| (lb/sq. in.) | force (g) | Thickness (in) | (in.²) | Surfactant | agent |
| 128-202 | | | | Glucopon 625 | 2% Kymene |
| 35-88 | | | | Glucopon 625 | no Kymene |
| 182 | | | | Pluronic 92 | 2% K & CaCl2 |
| 37.2 | | | | HTAB | 2% Kymene |
| 552.0 | 345 | 0.002756 | 0.001378 | Varisoft 442-100P | 2% K & CaCl2 |
| 152.0 | 95 | 0.002756 | 0.001378 | Varisoft 442-100P | 2% Kymene |
| 123.2 | 165 | 0.005906 | 0.0029528 | Varisoft 250-Witco | 2% K & CaCl2 |
| 30.5 | 30 | 0.004331 | 0.0021654 | Varisoft 250-Witco | 2% Kymene |
| 120.4 | 215 | 0.007874 | 0.003937 | IGEPAL CA-630 | 2% K & CaCl2 |
| 29.8 | 37.2 | 0.005512 | 0.0027559 | IGEPAL CA-630 | 2% Kymene |
| 125.3 | 235 | 0.008268 | 0.0041339 | BRIJ 35 | 2% K & CaCl2 |
| 55.0 | 65 | 0.005118 | 0.0025591 | BRIJ 35 | 2% Kymene |
| 301.0 | 322.5 | 0.004724 | 0.0023622 | BRIJ 52 | 2% K & CaCl2 |
| 30.6 | 35.5 | 0.005118 | 0.0025591 | BRIJ 52 | 2% Kymene |
| 51.7 | 60 | 0.005118 | 0.0025591 | Standapol ES-3#5c138 | 2% K & CaCl2 |
| 65.2 | 64 | 0.004331 | 0.0021654 | Standapol ES-3#5c138 | 2% Kymene |
| 129. | 230 | 0.007874 | 0.003937 | Pluronic L81 | 2% Kymene |
| 96.0 | 120 | 0.005512 | 0.0027559 | Pluronic L101 | 2% Kymene |
| 214.7 | 230 | 0.004724 | 0.002756 | BTC 50 TICI | 2% K & CaCl2 |
| 73.2 | 85 | 0.005118 | 0.0025591 | BTC 50 TICI | 2% Kymene |
| 19.2 | 44.5 | 0.010236 | 0.0051181 | BRIJ 52 | 2% Kymene |

### EXAMPLE 3

Additional foam sheets were made according to the process of Example 1 with 3% Avicel® as the cellulose source. Different drying methods and various surfactants were tested for effects on wet strength, shrinkage during regeneration, and strength index (ratio of wet strength to dry strength) of the foam sheets. A high ratio of wet strength to dry strength is considered very desirable in applications in which a cellulose product becomes wet during use, for example, a facial tissue or paper towel. The samples were either air dried, microwaved for 1 or 2 minutes, or dried in the oven for 30-35 minutes. The surfactant used was either Glupon 625, Pluronic F108, Pluronic 92, Synthrapol KB, or hexadecyltrimethylammonium bromide (HTAB). Shrinkage was determined by measuring the sheet with a ruler before and after the drying technique. The number represents the dried sample dimensions divided by the starting sample dimensions multiplied by 100. The results appear in Table 3, below.

TABLE 3

| Wet strength | | WetStrength/Dry | | |
|---|---|---|---|---|
| (lb/sq. in.) | Shrinkage (%) | Strength | Surfactant | Dry Method |
| 88.2 | 7.69 | 11.5 | Glupon 625 | Air |
| 13.7 | 16.2 | 0.84 | Glupon 625 | Air |
| 15.6 | 29.5 | | Glupon 625 | Air |
| 34.2 | 57.9 | 0.59 | Glupon 625 | Air |
| 7.9 | 31.1 | | Glupon 625 | Microwave 2 min. |
| 35.2 | 43.5 | 0.81 | Glupon 625 | Oven 35 min. |
| 20.1 | 25.8 | | Glupon 625 | Oven 30 min. |
| 201.7 | 31.2 | | Glupon 625 | Oven 30 min. |
| 37.2 | 45.5 | 0.82 | Glupon 625 | Oven 30 min. |
| 39.9 | 15.4 | 2.59 | Pluronic F 108 | Microwave 2 min. |
| 54.7 | 41.6 | 1.31 | Pluronic F 108 | Oven 30 min. |
| 21.6 | 53.8 | 0.40 | Pluronic F 168 | Oven 30 min. |
| 57.5 | 39.5 | 1.46 | Pluronic F 168 | Microwave 2 min. |
| 37.2 | 55.6 | | HTAB | Oven 30 min. |
| 39.5 | 68.0 | | HTAB | Microwave 2 min. |
| 37.7 | 12.3 | | Synthrapol | Oven 30 min. |
| 50.1 | 40.7 | 1.23 | Synthrapol | Oven 30 Min. |
| 16.0 | 20.9 | 0.76 | Synthrapol | Oven 30 Min. |
| 16.7 | 16.9 | 0.99 | Synthrapol | Air |
| 35.8 | 3.1 | 11.6 | Synthrapol | Air |
| 14.0 | 16.3 | 0.86 | Synthrapol | Microwave 2 min. |
| 25.1 | 28.1 | | Synthrapol | Microwave 2 min. |
| 30.0 | 20.8 | 1.44 | Synthrapol | Microwave 2 min. |
| 19.3 | 42.8 | 0.45 | Synthrapol | Microwave 2 min. |
| 43.3 | 16.9 | 2.56 | Synthrapol | Oven 30 min. |
| 36.7 | 18.4 | 2.00 | Synthrapol | Oven 30 min. |
| 31.9 | 22.2 | 1.44 | Synthrapol | Oven 30 min. |
| 56.1 | 14.8 | 3.79 | Synthrapol | Oven 30 min. V |
| 34.1 | 21.9 | 1.56 | Synthrapol | Oven 30 min. V |
| 61.5 | 21.8 | 2.82 | Synthrapol | Oven 30 min. V |
| 43.5 | 39.5 | | Pluronic 92 | Air |
| 183.0 | 31.2 | | Pluronic 92 | Air |
| 28.5 | 53.7 | | Pluronic 92 | Microwave 2 min. |
| 31.6 | 50.5 | | Pluronic 92 | Microwave 2 min. |
| 60.0 | 47.4 | | Pluronic 92 | Microwave 2 min. |
| 53.3 | 43.4 | | Pluronic 92 | Oven 30 min. |
| 66.5 | 43.7 | | Pluronic 92 | Oven 30 min. |
| 44.9 | 46.4 | | Pluronic 92 | Oven 30 min. |
| 88.5 | 61.0 | | Pluronic 92 | Oven 30 min. |

### EXAMPLE 4

Cellulose foam sheets were prepared according to the method of Example 1, with 3% cellulose. Surfactant and cross-linking agent were added and varied to evaluate effect on wet strength. The surfactant, if any, was either Glucopon 625 or SoleTerge. The cross-linking agent, if any, was either Kymene (1-2%) or Parez. The crosslinking agent may have been added with the surfactant or late in the foaming process. All samples were dried in a 70° C. oven for 30 minutes and evaluated for wet strength. The results are presented in Table 4, below.

TABLE 4

| Wet strength (lb/sq in.) | Surfactant | Dry Method | Crosslinkage |
|---|---|---|---|
| 127.7 | Glucopon 625 | Oven 30 min. | Kymene |
| 167.9 | Glucopon 625 | Oven 30 min. | Parez |
| 201.5 | Glucopon 625 | Oven 30 min. | 2% Kymene |
| 109.7 | Glucopon 625 | Oven 30 min. | 1% Kymene |
| 94.1 | Glu625 + 1% Ky | Oven 30 min. | 2% Parez |
| 95.5 | Glu625 + 1% Ky | Oven 30 min. | 2% Parez |
| 129.2 | Terge#8 + 2% Ky | Oven 30 min. | 2% Kymene |
| 72.2 | Terge#8 + 1% Ky | Oven 30 min. | 2% Parez |
| 135.1 | G1u625 + 1% Ky | Oven 30 min. | 2% Kymene |

### EXAMPLE 5

Additional foamed cellulose sheets were prepared according to the process of Example 1, using either 3 g of Mixed Office Waste (MOW) plus 3 g Avicel® or just 10 g Avicell® as the cellulose source. Various surfactants were employed, and Kymene or Kymene plus calcium chloride was added as a cross-linking agent (see table 5, below). All samples were oven dried at 70° C. for 30 minutes. The samples were analyzed for wet strength, breaking force, cross-sectional area, and sheet thickness. This data appears in table 5, below. These experiments demonstrate that other cellulose sources, such as MOW, can be used to create high-quality foam sheets.

TABLE 5
3 g MOW pulp + 3 g Avicel ®

| Wet strength | Breaking | | Cross | Thickness | | |
|---|---|---|---|---|---|---|
| (lb/sq. in.) | force (g) | Surfactant | section area | (in.) | Cross-linking | Dry method |
| 90.4 | 115 | Glucopon 625 | 0.0028 | 0.0055 | 2% Ky + | oven |
| | | | | | CaCl2 | |
| 82.5 | 67.5 | Glucopon 625 | 0.0018 | 0.0035 | 2% Kymene | oven |
| 203.1 | 360 | Pluronic 92 | 0.0039 | 0.0078 | 2% Ky + | oven |
| | | | | | CaCl2 | |
| 86.4 | 55 | Pluronic 92 | 0.0014 | 0.0028 | 2% Kymene | oven |
| 143.3 | 140 | Pluronic 68 | 0.00215 | 0.0043 | 2% Ky + | oven |
| | | | | | CaCl2 | |
| 39.6 | 45 | Pluronic 68 | 0.0025 | 0.005 | 2% Kymene | oven |
| 62.4 | 44 | Terge #8 | 0.00155 | 0.0031 | 2% Kymene | oven |
| 94.6 | 86 | Pluronic 92 | 0.002 | 0.0039 | 2% Kymene | oven |
| 203.1 | 120 | FC135 | 0.0013 | 0.0026 | 2% Kymene | oven |
| 66.9 | 36.5 | FC170C | 0.0012 | 0.0024 | 2% Kymene | oven |
| 76.1 | 41.5 | FC171 | 0.0012 | 0.0024 | 2% Kymene | oven |
| 21.7 | 34.5 | Phospholipid | 0.0035 | 0.007 | 2% Kymene | oven |

10 g Avicel ®

| Wet strength | Breaking | | Cross | | Cross- | |
|---|---|---|---|---|---|---|
| (lb/sq. in.) | force (g) | Surfactant | section area | Thickness | linking | Dry method |
| 56.6 | 36 | FC135 | 0.0014 | 0.0028 | 2% Kymene | oven |
| 47.1 | 30 | FC170C | 0.0014 | 0.0028 | 2% Kymene | oven |
| 52.2 | 38 | FC171 | 0.0016 | 0.0032 | 2% Kymene | oven |
| 68.5 | 40.5 | Phospholipid | 0.0013 | 0.0026 | 2% Kymene | oven |

### EXAMPLE 6

Foam cellulose sheets were prepared according to the process of Example 1, using either 5 g of MOW, 5 or 4 g of CR57, Southern Hardwood pulp, or 4 g of CR55, Southern Softwood pulp. Surfactants and cross-linking agents were also added (see table 6 below) and samples were freeze-dried, air dried, or oven dried at 70° C. for 30 minutes. The samples were then analyzed for properties such as wet strength, cross-sectional area, and breaking force. This set of experiments demonstrates that a high-quality foam sheet can be made from environmentally friendly cellulose sources such as MOW and wood pulp.

TABLE 6

| | Wet | Breaking | | | | | |
|---|---|---|---|---|---|---|---|
| Cellulose | strength | force | | Cross | Thickness | | Dry |
| source | (lb/sq. in.) | (g) | Surfactant | area | (in.) | Cross-linking | method |
| 5 g MOW | 28.3 | 38 | Pluronic | 0.00295 | 0.0059 | 2% Ky + CaCl2 | Freeze |
| | | | 92 | | | | |
| 5 g MOW | 16.3 | 26 | SoleTerge | 0.0035 | 0.0071 | 2% Ky + CaCl2 | Freeze |
| | | | #8 | | | | |
| 5 g MOW | 37.2 | 50.8 | Glucopon | 0.003 | 0.0059 | 2% Kymene | Freeze |
| | | | 625 | | | | |
| 5 g Cr57 | 11.9 | 32 | Glucopon | | 0.0059055 | 2% Kymene | Air |
| Southern | | | 625 | | | | |
| Hardwood | | | | | | | |
| 4 g Cr57 | 77.0 | 21 | Glucopon | 0.0006 | 0.0012 | 2% Kymene | oven |
| Southern | | | 625 | | | | |
| Hardwood | | | | | | | |
| 4 g Cr55 | 82.5 | 30 | Glucopon | 0.0008 | 0.0016 | 2% Kymene | oven |
| Southern | | | 625 | | | | |
| Softwood | | | | | | | |

### EXAMPLE 7

A tissue quality foam cellulose sheet was prepared according to the following procedure. 1.225 g of 72% zinc chloride and 2 g of calcium chloride are heated to approximately 65° C. 2.5 g of oven dried mixed office waste (MOW) was mixed with 17-20 ml of water until thoroughly wet, and then added to the zinc chloride/calcium chloride solution. This lowered the concentration of the cellulose/zinc chloride/calcium chloride mixture to approximately 67%. The mixture was then put into a blender on high for 5 minutes to completely dissolve the cellulose. Although the failure of ink, lignin, and clay to dissolve in the zinc chloride enables separation of the contaminants from the cellulose, no such contaminants were removed from the dissolved cellulose during this experiment.

The dissolved MOW was then placed in a mixing bowl and surfactants, Sole-Terge 8 (½ ml) and Dabco DC5604 (¼ ml), and the cross-linking agent, Kymene 557LX (2 ml), were added. The mixture was beat on high with a hand mixer for 2 minutes to form a foam. Following foaming, the foam was spread into thin sheets by placing the foam on Mylar® sheets and drawing over it with a stainless steel bar having a notch 0.020 in. high. The foam covered Mylar® sheets were then placed in a bath of isopropyl alcohol for approximately 30 minutes to remove the excess zinc chloride. The foam coagulated and released from the Mylar® while in the bath. Once the foam was floating in the alcohol, it was transferred to a water bath for approximately one hour to remove the zinc from the cellulose zincate, thereby regenerating the cellulose. At this point some shrinkage of the foam sheet occurred. The foams were then transferred to a 10% glycerol bath for approximately 30 minutes to improve the hand feel of the sheet.

After removal from the glycerol bath, the sheets were blotted dry with paper towels to remove excess water and then dried according to various methods, including freeze drying, drying with a desiccant, oven and air drying. The preferred methods were freeze drying, which took about 2 hours, or the use of anhydrous calcium sulfate as a desiccant, which took about five minutes. Freeze drying opened the foam structure, while drying with the desiccant closed the bubbles at the surface of the foam but retained the highly porous, open-celled foam structure in the interior of the sheet, creating a skin-like surface on the outside of the sheet, giving the added advantage of one product with differential wetting. After drying the sheets were calendered to reduce the stiffness.

### EXAMPLE 8

The foam sheets made according to the process set forth in Example 7 were analyzed for various properties and compared to representative commercial products such as 2-ply Kleenex® facial tissue and Surpass® paper towels. Properties analyzed were basis weight, bulk, wet and dry tensile strength in both the MD (machine direction, in this case the direction of the draw) and CD (cross-direction, in this case the direction across the liner of draw) directions, percent stretch, and opacity. Basis weight was found using 3.5 in. by 1.0 in. samples and bulk was determined using a TMI model 49-60 with a 3 inch diameter platen having a dead weight of 30 grams. All tensile strength and stretch measurements were taken on the Mini 55 Instron using 1 in. wide samples with a 2 in. jaw span. Opacities were found using a Technibrite Micro TB-1C. These results appear in the table below.

TABLE 7

| | | | |
|---|---|---|---|
| | STANDARD | | |
| FOAM SHEET | DEVIATION | KLEENEX ® | SURPASS ® |

I. Basis Weight & Bulk

| | | | |
|---|---|---|---|
| BASIS WEIGHT | 35 | 31 | 41 |
| BULK | 5.6 | 5.1 | 7.7 |

II. Percent Stretch

| | | | | |
|---|---|---|---|---|
| MD-Dry | 35 | 6.9 | 22 | 14 |
| MD-Wet | 29 | 4.1 | 15 | 16 |
| CD-Dry | 26 | 3.9 | | 7 |
| CD-Wet | 29 | 7.5 | 23 | 12 |

III. Tensile Strenth

| | | | | |
|---|---|---|---|---|
| MD-Dry | 407 | 133 | 347 | 1450 |
| MD-Wet | 285 | 73 | 98 | 443 |
| MD-Wet/Dry | 0.70 | | 0.28 | 0.31 |
| CD-Dry | 113 | 18 | 149 | 1463 |
| CD-Wet | 95 | 22 | 41 | 434 |
| CD-Wet/Dry | 0.84 | | 0.28 | 0.30 |

IV. Opacity

| | | | |
|---|---|---|---|
| % of STANDARD | 62 | 64 | 71 |
| CATEGORY | Premium (high | Super premium | Super premium |
| | 50's to low 60's) | (mid to high | |
| | | 60's) | |

What is claimed is:

1. A method for producing a carbohydrate foam composition comprising the steps of:
(a) pre-wetting at least one water-insoluble carbohydrate with a pre-wetting agent;
(b) mixing said pre-wetted carbohydrate with an aqueous solution capable of at least partially dissolving the carbohydrate;
(c) introducing a gas into said carbohydrate/aqueous solution to form a foam.

2. The method of claim 1, wherein the pre-wetting agent is water.

3. The method of claim 1, wherein the carbohydrate is selected from cellulose or chitin.

4. The method of claim 3, wherein the cellulose is selected from mixed office waste or fluffed pulp.

5. The method of claim 1, further comprising heating the aqueous solution prior to mixing with the carbohydrate.

6. The method of claim 5, wherein the temperature of the aqueous solution is maintained from about 20° to about 95° C.

7. The method of claim 5, wherein the temperature of the aqueous solution is maintained from about 60° to about 80° C.

8. The method of claim 5, wherein the temperature of the aqueous solution is maintained at about 65° C.

9. The method of claim 1, wherein the aqueous solution is an aqueous solution of ZnCl₂.

10. The method of claim 9, wherein the aqueous solution is from about 60% to about 75% ZnCl₂ in water.

11. The method of claim 9, wherein the aqueous solution is from about 65% to about 70% ZnCl₂ in water.

12. The method of claim 1, further comprising adding a salt to the aqueous carbohydrate solution prior to introducing the gas.

13. The method of claim 12, wherein the salt is CaCl₂

14. The method of claim 1, further comprising adding a surfactant to said carbohydrate aqueous solution prior to the introducing of the gas.

15. The method of claim 1, wherein the gas is selected from air, carbon dioxide, nitrogen, helium or argon.

16. The method of claim 1, wherein the introducing of the gas comprises mechanical frothing.

17. The method of claim 1, wherein the introducing of the gas comprises reaction with a blowing agent.

18. The method of claim 17, wherein the blowing agent is selected from the group consisting of carbon dioxide, nitrogen or ammonium chloride.

19. The method of claim 1, wherein said foam is regenerated with a regenerating agent.

20. The method of claim 19, wherein the regenerating agent is water.

21. The method of claim 19, wherein the aqueous solution comprises an aqueous solution of zinc chloride, and wherein excess zinc chloride is removed prior to regeneration.

22. The method of claim 21, wherein the removal of excess zinc chloride comprises contacting the foam with an organic solvent.

23. The method of claim 22, wherein the organic solvent is selected from ethanol, methanol, or isopropanol.

24. The method of claim 19 further comprising placing the regenerated foam in a glycerol bath.

25. The method of claim 1, further comprising drying the foam.

26. The method of claim 25, wherein the method of drying is selected from oven drying, microwave drying, freeze drying, chemical drying, or air drying.

27. The method of claim 1, wherein the at least one carbohydrate comprises at least two carbohydrates.

28. The method of claim 27, wherein the carbohydrates comprise cellulose and chitin.

29. A method for producing a carbohydrate foam composition comprising the steps of:
(a) pre-wetting a water-insoluble carbohydrate with a pre-wetting agent;
(b) mixing said pre-wetted carbohydrate with an aqueous solution;
(c) adding a surfactant to said carbohydrate/aqueous solution;
(d) introducing a gas into said carbohydrate/aqueous solution to form a foam; and
(e) regenerating said foam with a regenerating agent.

30. The method of claim 29, wherein the carbohydrate comprises a substantially water insoluble carbohydrate selected from cellulose or chitin.

31. The method of claim 29, wherein the carbohydrate comprises cellulose and the cellulose is selected from mixed office waste or fluffed pulp.

32. The method of claim 29, wherein the pre-wetting agent is water.

33. The method of claim 29, wherein the aqueous solution comprises zinc chloride.

34. The method of 32, further comprising removing excess zinc chloride prior to regeneration by contacting the foam with an organic solvent.

35. The method of claim 29, wherein the regenerating agent is water.

36. The method of claim 29, further comprising adding incompletely dissolved cellulose fiber to the carbohydrate/aqueous solution prior to the introduction of the gas.

37. The method of claim 29, further comprising spreading the foam onto a support substrate prior to regenerating the foam.

38. The method of claim 37, wherein the support substrate is selected from spunbonded webs, meltblown webs or extruded sheets.

39. The method of claim 37, wherein the support substrate comprises a non-woven polyolefin material.

40. The method of claim 39, wherein the non-woven polyolefin material is selected from spunbonded or meltblown polypropylene.

41. The method of claim 29, further comprising drying the regenerated foam.

42. The method of claim 41, wherein the method of drying is selected from the group consisting of oven drying, microwave drying, freeze drying, chemical drying, and air drying.

43. The method of claim 29, further comprising mechanically opening the cells of the foam.

44. The method of claim 43, wherein the cells of the foam are mechanically opened by rolling a roller over the surface of the regenerated foam.

45. A method for producing a carbohydrate foam sheet comprising the steps of:
(a) pre-wetting a water-insoluble carbohydrate with a pre-wetting agent;
(b) mixing said pre-wetted carbohydrate with an aqueous solution;
(c) adding a surfactant to said carbohydrate/aqueous solution;
(d) adding a cross-linking agent to said carbohydrate/aqueous solution;
(e) introducing a gas into said carbohydrate/aqueous solution to form a foam;
(f) spreading said foam into a thin sheet; and
(e) regenerating said foam sheet with a regenerating agent.

46. The method of claim 45, wherein the carbohydrate is selected from cellulose or chitin.

47. The method of claim 46, wherein the cellulose is selected from mixed office waste or fluffed pulp.

48. The method of claim 45, wherein the aqueous solution comprises an aqueous solution of zinc chloride.

49. The method of claim 45, wherein the aqueous solution comprises an aqueous solution of zinc chloride and calcium chloride.

50. The method of claim 48, further comprising removing the excess zinc chloride prior to regeneration by contacting the foam sheet with an organic solvent.

51. The method of claim 47, wherein the foam is spread onto a temporary support prior to regeneration.

52. The method of claim 51, wherein the temporary support comprises a polyester sheet or a polytetrafluoroethylene coated glass sheet.

53. The method of claim 45, further comprising placing the regenerated foam sheet into a glycerol bath.

54. The method of claim 45, further comprising drying the foam sheet.

55. The method of claim 45, further comprising calendering the foam sheet.
